(19) United States
(12) Patent Application Publication
(10) Pub. No.: US 2005/0242128 A1
(43) Pub. Date: Nov. 3, 2005

(54) Dispenser for highly viscous liquids and pastes

(76) Inventor: Jolly Fields Izoe, Oklahoma City, OK (US)

Correspondence Address: Jolly Fields Izoe, 2600 N.W. 63rd St., #99, Oklahoma City, OK, 73116-4928, US

(21) Appl. No.: 11/176,151

(22) Filed: Jul. 8, 2005

Related U.S. Application Data
(63) Continuation-in-part of application No. 10/826,795, filed on Apr. 16, 2004.

(51) Int. Cl. B67D 5/42

(52) U.S. Cl. 222/390

(57) ABSTRACT

A dispenser with leverage to precisely control amount of highly viscous liquids and pastes dispensed, to preserve integrity of product by keeping air away from product until dispensed, actuator rod coordinating with ram to maintain concentricity as ram is forced down to dispense product, having a reverse feature that relieves product back pressure and allows excess product at nozzle tip to be pulled back into container to maintain a clean nozzle tip, and to dispense virtually all product.

### BACKGROUND OF THE INVENTION

The present invention relates to a dispenser with leverage to precisely control amount of highly viscous liquids and pastes dispensed, to preserve the integrity of the product by keeping air away from product until dispensed, to dispense virtually all product from dispenser, having a reverse feature that relieves product back pressure and allows excess product at tip to be pulled back into container to maintain a clean nozzle tip.

There are a large number of dispensers available which are useful to dispense such food products as mayonnaise, catsup, mustard, and the like, as well as toothpaste and other products. In conventional containers for dispensing these viscous liquids, the product within the dispenser becomes exposed to air once the seal is broken and some of the contents are dispensed. Moisture in the air above the product condenses when the dispenser is placed in the refrigerator for storage between uses—thereby depositing water on the product. Dispensers placed on counters in fast food and other restaurants represent an unsanitary condition due to ambient air coming into contact with the liquid within the dispenser. There are no inexpensive dispensers available which have leverage to dispense highly viscous products as caulking and peanut butter, to keep air away from product , to relieve back pressure and maintain a clean nozzle tip.

A number of patents have been issued which disclose dispensers of viscous liquids. U.S. Pat. No. 3,999,691 discloses a cake filler dispensing apparatus for semi-fluid material having a housing with a vertical bore and a second bore with a piston connecting with this vertical bore. APPARATUS IS COMPLICATED IN STRUCTURE.

U.S. Pat. No. 4,050,612 shows a dispensing container for flowable materials such as creams—includes a pair of opened ended containers nested telescopically with a piston in the upper container. DISPENSER IS INCONVENIENT TO USE AND DOES NOT ALLOW PRECISE DISPENSING OF PRODUCT.

U.S. Pat. No. 4,154,371 is a dispensing container with a piston forming the bottom of the container with a compressible container, lying in front of the piston and having a mouthpiece. Expelling of the product from the mouthpiece would have a vacuum effect to pull the piston upward. LEVERAGE TO PULL PRODUCT TO ORFICE IS LIMITED.

U.S. Pat. No. 4,323,177 shows an injection piston for use in cylindrical dispensing containers or packages of the type containing viscous or plastic masses such as sealing compounds or adhesives. Ejection pressure is used to increase the effective diameter of the piston top to seal air from product during ejection. PISTON PRESSURE BY COMPRESSED AIR IS COMPLICATED AND INCONVENIENT.

U.S. Pat. No. 4,479,592 describes a dispenser for providing measured amounts of a paste in which actuator is depressed down. Piston casing cannot move down because of the gripping action of a reed spring clip. When actuator is released, spring clip pushes piston upward to dispense measured amount. LEVERAGE IS LIMITED TO STRENGTH OF SPRING CLIP. DOES NOT PROVIDE COMPLETE SEALING OF PRODUCT.

U.S. Pat. No. 4,767,032 has a dispenser with a hollow dispensing tube reciprocating within the container which incrementally moves a piston downward for forcing paste upward. Ratchet has outward projecting spring with tangs to grip the smooth inner cylinder. LEVERAGE IS MINIMAL. DOES NOT MAINTAIN A CLEAN EJECTION TIP.

U.S. Pat. No. 4,886,186 discloses a dispenser for the delivery of dosed amounts of a pasty substance having a push button mounted on the receptacle for movement upwardly and downwardly adjacent an end thereof. A toothed rod extends through the receptacle and is connected at its inner end to a follower plunger. Upward movement of plunger is effected either by vacuum or a spring. LEVERAGE IS WEAK. SEALING IS INEFFECTIVE.

U.S. Pat. No. 5,170,913 shows a container with a discharge outlet and a pliant tubular wall. Squeezing of pliant tubular wall expels product. A piston follower has seals that slide on inner wall to prevent entry of air into product. SQUEEZING OF PLIANT TUBE WOULD NOT EXERT ENOUGH FORCE TO ASSURE PISTON FOLLOWER WOULD SLIDE INSIDE PLIANT TUBE.

U.S. Pat. No. 5,547,107 shows a dispenser for flowable materials which includes an outer barrel telescoped over a sealable plunger. Moving outer barrel down forces product out spout in barrel. NO LEVERAGE ADVANTAGE. PROBLEM IN MAINTAINING CONCENTRICITY.

U.S. Pat. No. 5,720,416 has a dispenser for viscous liquids in which two vane blades rotate to close out on two stationary walls in circular chamber with the ability to dispense two products simultaneously. THERE IS NO LEVERAGE ADVANTAGE AS KNOB ROTATING VANE BLADES MOVES SAME AMOUNT AS VANE BLADES.

U.S. Pat. No. 6,655,557 B2 describes a dispensing device for dispensing a viscous product as a cream or gel. Top of device has outer threads that are manually rotated through inner threads of container to force out product. DEVICE WOULD BE HARD TO ROTATE AND DIFFICULT TO MANUFACTURE.

None of the above patents teaches the present invention.

### SUMMARY OF THE INVENTION

This invention provides a dispenser with leverage to precisely control amount of highly viscous liquids and pastes dispensed, to preserve integrity of the product by keeping air away from product, to dispense virtually all product, having a reverse feature that relieves product back pressure and allows excess product at tip to be pulled back into container to maintain a clean nozzle tip.

A dispenser for highly viscous liquids and pastes in which a hollow cylinder is provided with threaded nozzle to attach threaded cap. Cylinder is filled with product. Ram with outer walls and center hub is inserted on top of product. As ram slides down, top outer walls of ram provide seal against inner wall of cylinder. Cylinder top has threads that allow hold top to be screwed on cylinder outer diameter.

Reverse rod is inserted through top of threaded actuator hollow rod. Knob grooves are forced down onto actuator top two ribs to lock assembly together. Actuator rod threads are screwed downward through hold top center threaded hub—rotating actuator hollow rod walls on outside of ram center hub and inside another hub wall. This action moves ram toward nozzle opening—without rotating ram.

Driving force against ram is at very bottom circular wall of actuator hollow rod. This design provides even distribution of force against ram to prevent ram from tilting. In addition, any tendency of ram to tilt would be counter-acted by rotation of actuator hollow rod vertical wall against both inside ram hub and ram wall on outside of actuator rod wall. This assures ram slides smoothly down to force product out nozzle tip. In addition, top wall of ram is manufactured of material that has some flexibility to conform to the inner wall of hollow cylinder—to keep ram in alignment with cylinder inner walls.

Reverse rod bottom left hand threads screw into ram center hub. Bottom diameter of disk near top of reverse rod is slightly above actuator rod top wall. Top of reverse rod disk has rod bearing with screw-driver slot—that projects upward into center hole of knob. Reverse rod disk top has clearance between knob bottom—so reverse rod can move upward. Rotation of knob to dispense product moves ram down vertically but does not rotate ram. Reverse rod attached to ram hub moves downward with ram hub and actuator rod. Knob center hole rotates around reverse rod bearing that has screw-driver slot.

Knob, actuator, reverse rod, hold top are made of very durable material for re-usable actuating gun. Screw-driver slot in top of reverse rod bearing allows reverse rod to be screwed out of ram center hub and taken out of emptied cylinder without disassembling knob, actuator, reverse rod. This actuating gun can be placed on new re-fill tube—which would have ram already inserted over product. In most cases, nozzle would have tamper-proof seal with nozzle cap attached. Cylinder top would have heavy tamper-proof seal which would be removed prior to hold top being screwed on cylinder. Actuating gun would be inserted. Reverse rod bottom threads would be screwed into ram center threaded hub.

Reverse rod is thus locked to ram hub and performs no function as ram moves downward. When knob is reversed, actuator rod top wall moves upward against bottom of reverse rod disk. Since ram is locked to reverse rod—with ram having vacuum lock on product, further reverse rotation lifts ram upward to relieve product back pressure and pull excess product at tip back into cylinder. With actuator rod having right hand threads, reverse rod tip and ram hub would have left hand threads—so upward motion could not unscrew reverse rod from ram hub. Product can be dispensed over a period of time without the need for nozzle cap to prevent leakage.

When bottom of ram horizontal wall is moved downward against cylinder bottom wall, there would still be product left in nozzle. Reverse rotation of knob of approximately one complete turn would pull air into cylinder. Forward rotation would cause air to expel product from nozzle. By rotating knob backward and forward, virtually all product could be expelled from cylinder.

Knob could be at bottom and locked in appropriate holder—so that rotation of cylinder would pull product—as artists' paints, lotions, bean—cheese dips, etc.—into a custom designed nozzle for such products. A tremendous advantage for artists' paints is that any paint left in custom nozzle could be pulled back into cylinder by reverse action. Cylinder can be placed in horizontal position. Products that have oil rising to top—such as natural peanut butter—would have oil automatically integrated into mixture with nozzle section-cylinder rotating with knob locked in appropriate holder.

It is thus a principal object of this invention to provide an inexpensive, convenient, efficient and effective apparatus for the dispensing of highly viscous liquids as caulking and peanut butter as well as a large number of food, medical and industrial products, to keep air away from product, to control amount dispensed, to stop back pressure on reversal of knob and maintain a clean nozzle tip and to dispense virtually all product from cylinder.

Other objects and advantages of this invention will hereinafter become obvious from the following detailed description of preferred embodiments of this invention.

### BRIEF DESCRIPTION OF THE DRAWINGS

The following figures illustrate preferred embodiments of the dispenser of this invention:

FIG. 1 is perspective top view of the the preferred embodiment of assembled parts of invention.

FIG. 2 is perspective inside view of P6B Nozzle cap (large) showing strengthening struts and center threads.

FIG. 3 is perspective top view of P3 Actuator threaded rod, two top ribs to lock in P1 Knob grooves.

FIG. 4 is perspective bottom view of P4 Hold top with threads for P7 Cylinder and center threaded hole for P3 Actuator threads.

FIG. 5 is perspective top view of P5 Ram with outer wall, strengthening struts and center threaded hub.

FIG. 6 is perspective bottom view of P5 Ram configuration which matches P7 Cylinder inner bottom.

FIG. 7 is perspective top view of assembled P2 Reverse rod inside P3 Actuator rod and P5 Ram.

FIG. 8 is perspective top view of P5 Ram with outer walls, inner walls, struts and center threaded hub.

FIG. 9 is perspective top view of P2 Reverse rod with screw-driver top slot, disk and threaded bottom.

FIG. 10 is perspective bottom view of P1 Knob with vent holes and two grooves for P3 Actuator ribs.

FIG. 11 is perspective top view of P3 Actuator hollow rod with two top ribs, threads and bottom hub.

FIG. 12 is perspective bottom view of P5 Ram with same configuration as P7 Cylinder inner bottom.

FIG. 13 is perspective bottom view of P4 Hold top with struts, threads for P3 Actuator, P7 Cylinder.

FIG. 14 is perspective top view of P7 Cylinder with threads for P4 Hold top, P6 (P6B) Nozzle bottom cap.

FIG. 15 is perspective bottom view of P3 Actuator rod with bottom hub that rotates around P5 Ram hub.

FIG. 16 is perspective bottom view of P5 Ram with same configuration as P7 Cylinder inner bottom.

### DESCRIPTION OF THE PREFERRED EMBODIMENTS

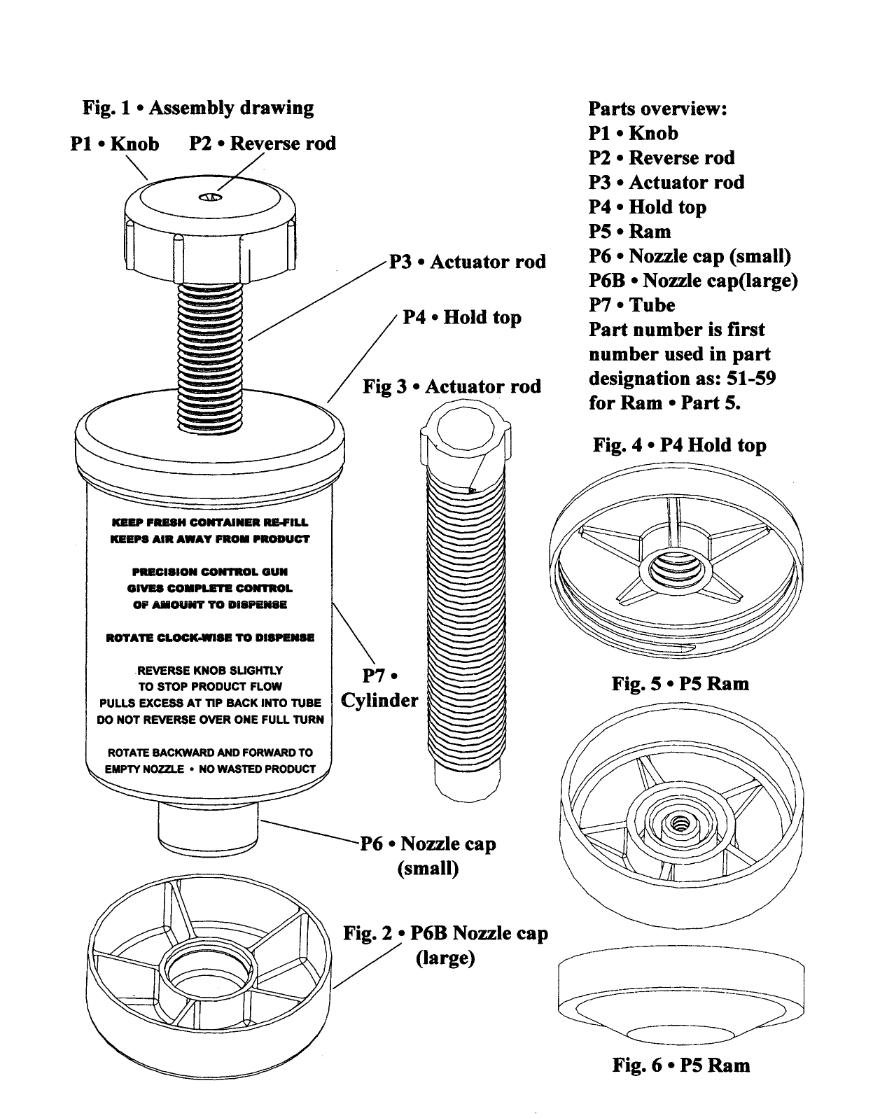

Referring to FIGS. 1-16, dispenser comprises P7 Cylinder (FIGS. 1, 14) to hold product. Tamper-proof seal (not shown) is attached to P7 Cylinder nozzle bottom 79 (FIG. 14). P6 (P6B) Nozzle cap (FIGS. 1, 2) is screwed on P7 Cylinder threads 77a-77b (FIG. 14). Cylinder is filled with product slightly below level of 74a. P5 Ram (FIG. 8, 12) is inserted from top of P7 Cylinder (FIG. 14). Product and P5 Ram wall 57b would be even with P7 Cylinder inner wall 74a. Large tamper-proof seal (not shown) would be glued to P7 Cylinder top wall 71-72 (FIG. 14). This re-fill is titled: “Keep-Fresh Container”—Trademark Registration No. 12031186 with State of Okahoma, Feb. 26, 2004.

P1 Knob, P2 Reverse rod, P3 Actuator rod, P4 Hold top assembly is made of very durable plastic to be taken off emptied re-fill container and placed on new re-fill container. This re-usable assembly is titled: “Precision Control Gun”—Trade-mark Registration No. 12068623 with State of Oklahoma, Apr. 4, 2005.

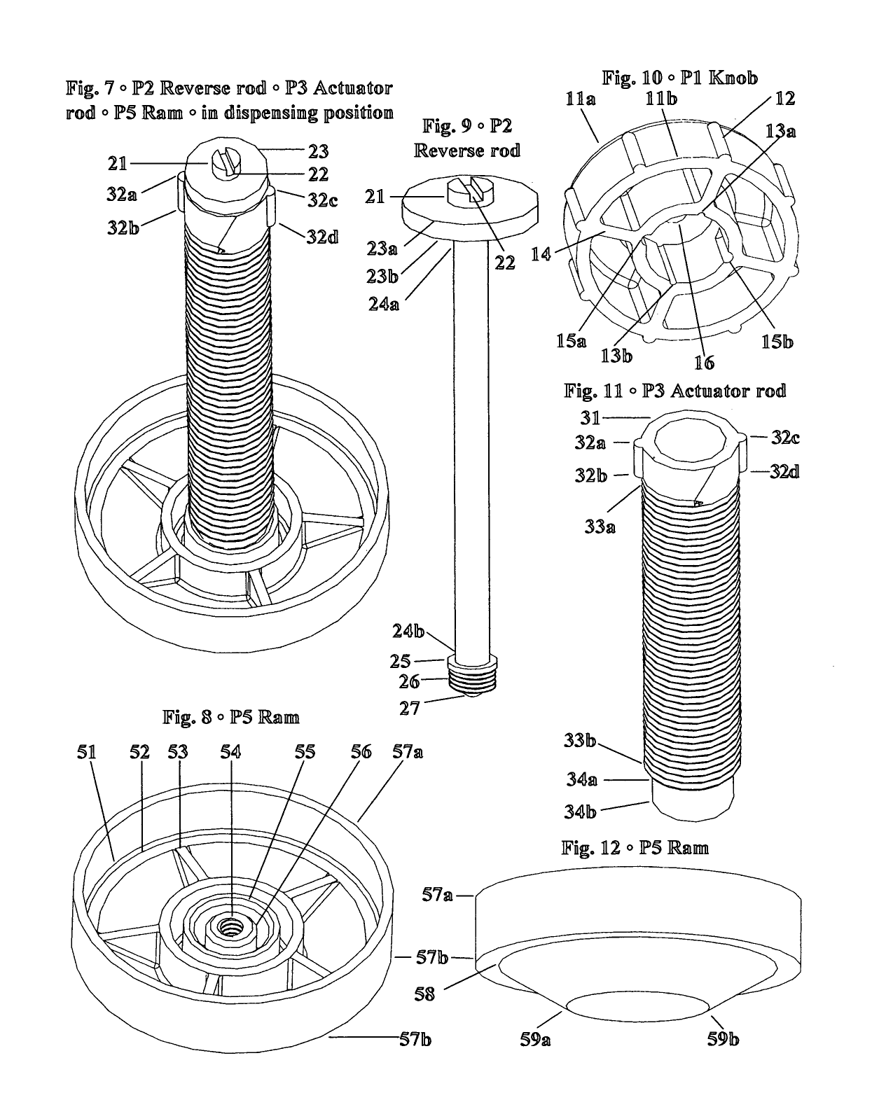

This re-usable assembly has P2 Reverse rod (FIGS. 7, 9) inserted into top of P3 Actuator hollow rod (FIGS. 7, 11, 15). Two grooves 15a, 15b of P1 Knob (FIG. 10) are pressed down over the two ribs 32a-32b, 32c-32d of P3 Actuator rod (FIGS. 7, 11, 15) to lock assembly together. Two grooves 13a, 13b (FIG. 10) allow air to vent above P5 Ram in event dust or moisture seal is placed over P1 Knob hole 16.

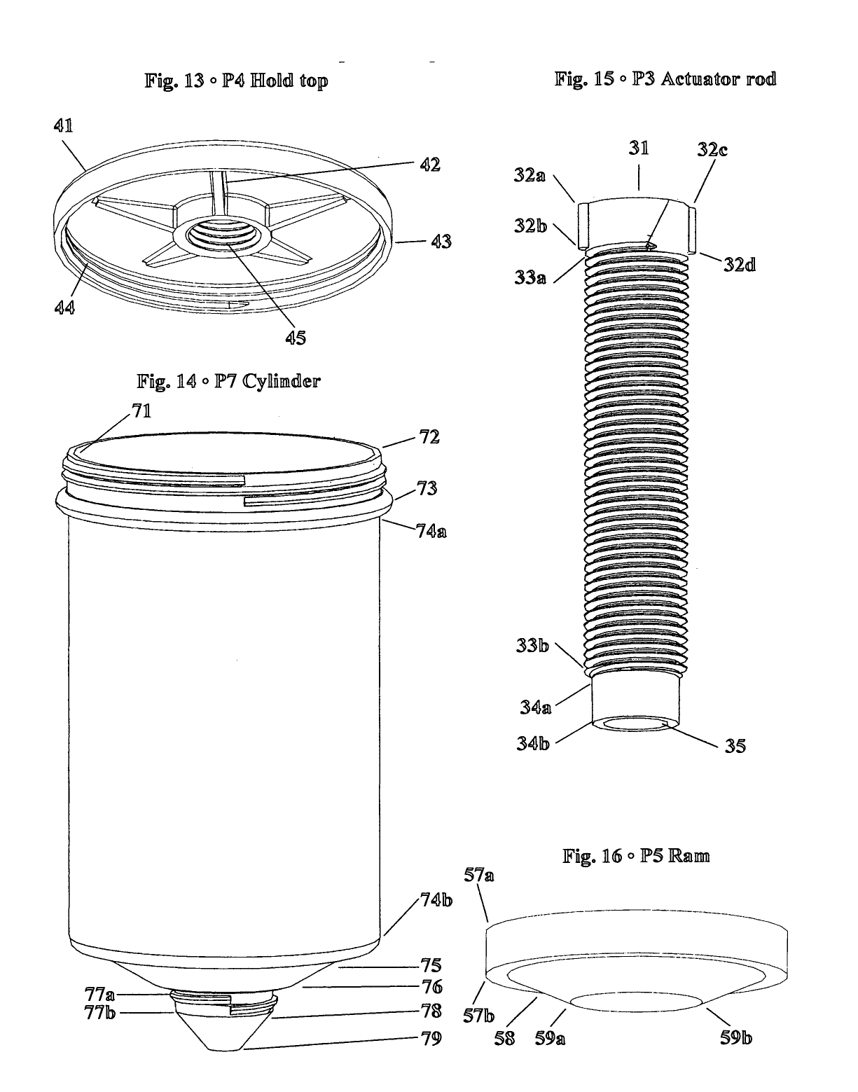

When ready for dispensing, large tamper-proof seal (not shown)—and if necesary—screw-on cover (not shown) would be removed from top of P7 Cylinder top 71-72 (FIG. 14). P4 Hold top (FIGS. 1, 4, 13) is part of “Precision Control Gun”. Large diameter inner threads 44 (FIG. 13) are screwed onto P7 Cylinder top 71-72 to 73 (FIG. 14) with P4 Hold top inner wall against P7 Cylinder top wall 71-72.

P3 Actuator rod threads at 33b (FIGS. 11, 15) are screwed through P4 Hold top center threaded hole 45 (FIGS. 13) downward so that Actuator hollow rod wall 35 (FIG. 15) is around outside of P5 Ram center hub wall 56 (FIG. 8) and inside wall 55. P5 Ram wall 55 and inner wall 56 (FIG. 8) are beveled to facilitate entry of P3 Actuator rod inner wall 35 and outer wall 34b (FIG. 15).

P2 Reverse rod beveled tip 27 (FIG. 9) facilitates alignment of threads 26 into P5 Ram hub threads 54 (FIG. 8). P2 Reverse rod flange bottom 25 (FIG. 9) positions P2 Reverse rod disk bottom 23b to be slightly above P3 Actuator rod top wall 31 (FIG. 11). P5 Ram does not rotate as it is moved down by P3 Actuator rod to dispense product. When P1 Knob—attached to P3 Actuator rod—is reversed a small amount (FIGS. 1, 7), P3 Actuator top wall 31 moves up against P2 Reverse disk bottom 23b (FIG. 9). Further reversal causes P3 Actuator top 31 to lift P2 Reverse rod. P5 Ram locked to P2 Reverse rod moves upward to relieve back pressure and pull excess product at Nozzle tip back into P7 Cylinder.

P5 Ram has five strengthening struts that extend out to diameter 53 . . . (FIG. 8). P5 Ram wall from diameters 52-51 does not have stengthening struts. This allows more flexibility of P5 Ram wall 57a-57b (FIGS. 8, 12) against P7 Cylinder inner wall 74a-74b (FIG. 14) to provide better seal as P5 Ram is forced downward to dispense product.

P3 Actuator rod threads 33b-33a (FIG. 11, 15) going through P4 Hold top center threads 45 (FIGS. 1, 4, 13) provide great leverage to dispense highly viscous products as caulking and peanut butter. P1 Knob (FIG. 1) can be precisely rotated to dispense amount of product desired. Reversal of P1 Knob brings P3 Actuator rod top 31 (FIGS. 11, 15) up against P2 Reverse rod disk bottom 23b (FIG. 9) to move P5 Ram upward. Since P5 Ram has vacuum lock on product, back pressure is relieved and product excess at nozzle tip 79 (FIG. 14) is pulled back into P7 Cylinder to maintain clean nozzle tip.

When bottom of P5 Ram horizontal wall is moved downward against P7 Cylinder bottom wall, there would still be product left in nozzle. P5 Ram bottom wall 57b-58, wall 58-59a (FIGS. 8, 12, 16) have same configuration as P7 Cylinder inner walls (FIG. 14) from 74b-75, 75-76. P5 Ram wall 59a-59b extends slightly over P7 Cylinder nozzle hole top inner diameter. Reverse rotation of P1 Knob of approximately one complete turn would pull air inside P7 Cylinder. Forward rotation of P1 Knob would cause air to expel product from P7 Cylinder nozzle. By rotating P1 Knob backward and forward, virtually all product could be expelled from Cylinder.

P2 Reverse rod in cordination with P3 Actuator rod and P5 Ram represent a unique action in that P5 Rain does not rotate; is able to be forced down by P3 Actuator rod and pulled upward by P3 Actuator hollow rod top against P2 Reverse rod disk bottom. Many variations are possible by having customized nozzles and holders—as for artists' paints—bean, cheese dips, shoe polish applicators, tooth paste and many type cosmetics as well as a vast multitude of medical, commercial, industrial uses—some of which may require exact measuring of product.

It is thus seen—a dispenser has been provided that is easily rotated—with great leverage for precise control of amount dispensed—in comparison to the pressure required by ratchet action of present caulking guns. Air is kept away from product to maintain integrity of product—after initial opening by consumer. Virtually all product can be expelled from container. Reverse feature relieves back pressure and pulls excess product back into container to maintain clean nozzle tip.

While only preferred embodiments of this invention have been described, it is understood that many variations are possible without departing from the principles of this invention as defined in the claims which follow.

1. A dispenser for viscous and highly viscous liquids and pastes comprising:
(a) having P1 Knob with provision for locking to P3 Actuator hollow rod—so rotation of P1 Knob rotates P3 Actuator hollow rod; with provision for P1 Knob top hole to rotate around P2 Reverse rod top bearing with screw-driver slot; with provision for venting through inner part of P1 Knob.
(b) having P2 Reverse rod with provision for inserting into top of P1 Knob with screw-driver slot on top of Reverse rod bearing—for P1 Knob hole to rotate around P2 Reverse rod top bearing; with provision for P2 Reverse rod top disk to be positioned slightly above P3 Actuator hollow rod top; with provision for P2 reverse rod bottom to be threaded into P5 Ram center hub; with ability of P2 Reverse rod to act as assembly with P1 Knob, P3 Actuator hollow rod—so that assembly can be unscrewed from P5 Ram center hub and transferred intact from emptied to new re-fill P7 Cylinder.
(c) having P3 Actuator hollow rod with provision for two ribs to lock to two grooves of P1 Knob, with provision for outer threads to screw through P4 Hold top center hub threads; with provision for P3 Actuator hollow rod bottom hub wall to rotate around P5 Ram center hub and inside P5 Ram next circumference wall; with provision for P3 Actuator rod wall bottom to force P5 Ram down on rotation of P1 Knob—with action of P3 Actuator hub walls and bottom maintaining concentricity of P5 Ram; with provision for P2 Reverse rod to be inside P3 Actuator hollow rod and allow P2 Reverse rod to be lifted upward on reverse rotation of P1 Knob to relieve back pressure and maintain clean nozzle tip.
(d) having P4 Hold top with provision for large diameter inner threads to screw onto P7 Cylinder threaded top; having center hub threaded hole to allow P3 Actuator hollow rod outer threads to screw through—providing leverage to dispense highly viscous products as caulking and peanut butter.
(e) having P5 Ram with provision for top outer flexible wall to seal against P7 Cylinder inner wall; with provision for P3 Actuator hollow rod bottom to rotate against P5 Ram bottom wall to force P5 Ram downward to dispense product; with provision for P3 Actuator hollow rod inner and outer vertical walls to rotate around P5 Ram hub and inside P5 next circumference wall—allowing P3 Actuator walls to keep P5 Ram from tilting and to bring P5 Ram back into concentricity; with provision for P5 Ram center hub to receive P2 Reverse rod bottom threads; with provision for P2 Reverse rod to lift P5 Ram on reversal of P1 Knob.
(f) having P6 Nozzle cap to lock on P7 Cylinder nozzle with tamper-proof seal on nozzle tip.
(g) having P7 Cylinder to hold product—with nozzle threads at one end for P6 Nozzle cap—opposite open end with threads to receive P4 Hold top, and coordinating with P3 Actuator hollow rod, P2 Reverse rod, P5 Ram to precisely dispense amount of product desired and to keep nozzle tip clean.

2. The dispenser of claim 1 in which said P1 Knob, P2 Reverse rod, P3 Actuator hollow rod—as an assembly can be kept intact on transferring from emptied P7 Cylinder re-fill to new P7 Cylinder re-fill.

3. The dispenser of claim 1 in which P1 Knob hole 16 can rotate around P2 Reverse rod top bearing 21 with screw-driver slot 22 to allow assembly of P1 Knob, P2 Reverse rod, P3 Actuator rod to be transferred from emptied P7 Cylinder re-fill to new P7 cylinder re-fill without being disassembled.

3. The dispenser of claim 1 in which said P2 Reverse rod has top screw-driver slot 22 to allow screwing of P2 Reverse rod bottom threads into and out of P5 Ram center hub threads while keeping P1 Knob, P2 Reverse rod and P3 Actuator assembly intact; with means to pull P5 Ram upward on reversal of P1 Knob attached to P3 Actuator—to relieve product back pressure and maintain clean P7 nozzle tip; with provision when P5 Ram is at P7 Cylinder bottom—to rotate P1 Knob forward and reverse to move P5 Ram up and down—to completely empty P7 Cylinder nozzle.

4. The dispenser of claim 1 in which said P3 Actuator hollow rod—attached to P1 Knob—in coordination with P5 Ram center hub and P7 Cylinder—have leverage to precisely control amount dispensed of viscous products as tooth-paste and highly viscous products as caulking and peanut butter.

5. The dispenser of claim 4 in which said P3 Actuator rod bottom wall 35 rotating on outside of P5 Ram bottom wall 56 maintains concentricity of P5 Ram as it is forced downward.

6. The dispenser of claim 4 in which rotation of P3 Actuator inner wall 34a-34b rotating inside P5 Ram hub bottom wall 55 keep P5 Ram in concentricity as it is forced downward.

7. The dispenser of claim 1 in which said P5 Ram—in coordination with P3 Actuator rod—has provision to be forced downward to dispense product—without being rotated; with provision to lock to P2 Reverse rod—so that on reversal of P1 Knob, P5 Ram can be lifted upward to relieve product back pressure and pull excess at nozzle tip back into P7 Cylinder to maintain clean nozzle tip.

8. The dispenser of claim 7—that in event P5 Ram did tilt slightly—P3 Actuator hollow rod vertical inner wall 35 rotating around P5 Ram center hub wall 56 and P3 Actuator rod outer vertical wall 34a-34b rotating inside P5 Ram wall 55—would bring P5 Ram back into concentricity.
